(19) United States
(12) Patent Application Publication
(10) Pub. No.: US 2026/0138296 A1
(43) Pub. Date: May 21, 2026

(54) RAZOR CARTRIDGE WITH ADJUSTABLE BLADES

(71) Applicant: EMERY SHAVING SUPPLIES LLC, Atlanta, GA (US)

(72) Inventors: Daniel REFAI, M.D., Atlanta, GA (US); Scott ENNIS, Jacksonville, FL (US); Lasa ENNIS, Jacksonville, FL (US); Julie FRIEDBERG, Johns Creek, GA (US)

(73) Assignee: EMERY SHAVING SUPPLIES LLC, Atlanta, GA (US)

(21) Appl. No.: 19/447,742

(22) Filed: Jan. 13, 2026

Related U.S. Application Data
(63) Continuation of application No. PCT/US2024/037711, filed on Jul. 12, 2024.
Application No. PCT/US2024/037711 is a continuation of application No. 18/269,701, now abandoned.
(60) Provisional application No. 63/513,673, filed on Jul. 14, 2023.

(30) Foreign Application Priority Data
Dec. 24, 2020 (JP) 2020-215203
Dec. 24, 2020 (JP) 2020-215335
Jul. 7, 2021 (JP) 2021-112658
Jul. 7, 2021 (JP) 2021-112876
Jul. 12, 2021 (JP) 2021-115152

(51) Int. Cl. B26B 21/22; B26B 21/40

(52) U.S. Cl. CPC B26B 21/222; B26B 21/4025; B26B 21/4031; B26B 21/4062

(57) ABSTRACT

A razor cartridge includes a plurality of parallel blades. Each blade includes a longitudinal cutting edge. A blade housing is configured to accommodate the plurality of blades. The blades are positioned longitudinally across the blade housing, with the cutting edges of the blades forming a shaving plane. A shifting mechanism is configured to rotate the plurality of blades between a first shaving position and a cleaning position. In the first shaving position the blades are each oriented at an acute first shaving angle relative to the shaving plane and the blades are each spaced apart a first shaving distance. In the cleaning position the blades are each oriented at a cleaning angle relative to the shaving plane and the blades are each spaced apart a cleaning distance. The cleaning angle is larger than the first shaving angle and the cleaning distance is larger than the first shaving distance.

### CROSS REFERENCE TO RELATED APPLICATION

This application is a bypass continuation of PCT Application No. PCT/US2024/037711, filed Jul. 12, 2024, and entitled “Razor Cartridge with Adjustable Blades,” which claims benefit of priority of U.S. Provisional Patent Application No. 63/513,673 , filed on Jul. 14, 2023, and entitled “Razor Cartridge with Adjustable Blades” the disclosures of each of these applications are hereby incorporated herein by reference in their entirety.

### TECHNICAL FIELD

The present disclosure relates to razor cartridges. More specifically, the disclosure relates to razor cartridges wherein the razor blades can be adjusted from a shaving position to a cleaning position.

### BACKGROUND

Razor cartridges include a plurality of parallel blades that are locked in an acute shaving angle with the shaving surface or shaving plane. However, it can be problematic to thoroughly clean residual hair, lotions, creams, soaps and other residue from the space between adjacent blades of a such a razor cartridge system. Over time, build-up of residues will dull the razor blades and can lead to razor burn, bumps, and irritation, including an exacerbation of skin conditions such as acne or eczema.

Accordingly, there is a need for razor cartridge wherein the residue between the blades can be more easily and thoroughly cleaned out from between adjacent blades.

### SUMMARY OF THE INVENTION

The present disclosure offers advantages and alternatives over the prior art by providing a razor cartridge with adjustable blades that can be moved between at least one shaving position to a cleaning position. In the cleaning position, the distance between adjacent blades is increased relative to the distance between the blades in the shaving position. Accordingly, the blades in the cleaning position can be more easily and thoroughly cleaned of residue built up during a shaving procedure.

A razor cartridge in accordance with one or more aspects of the present disclosure includes a plurality of parallel blades. Each blade includes a longitudinal cutting edge. A blade housing is configured to accommodate the plurality of blades. The blades are positioned longitudinally across the blade housing, wherein the cutting edges of the blades form a shaving plane. A shifting mechanism is configured to rotate the plurality of blades between a first shaving position and a cleaning position. In the first shaving position the blades are each oriented at an acute first shaving angle relative to the shaving plane and the blades are each spaced apart a first shaving distance. In the cleaning position the blades are each oriented at a cleaning angle relative to the shaving plane and the blades are each spaced apart a cleaning distance. The cleaning angle is larger than the first shaving angle and the cleaning distance is larger than the first shaving distance.

Another razor cartridge in accordance with one or more aspects of the present disclosure includes a plurality of parallel blades. Each blade includes a longitudinal cutting edge and an opposing longitudinal non-cutting edge. A blade housing is configured to accommodate the plurality of blades therein. The blades are positioned longitudinally across the blade housing. An actuator is configured to rotate the plurality of blades between a shaving position and a cleaning position. The actuator is movable from a latched position to an unlatched position. The actuator includes a base plate having a first surface configured to abut against an outer surface of a rear wall of the housing and an opposing second surface. The base plate is configured to move laterally up and down the rear wall between the latched position and the unlatched position of the actuator. The actuator also includes a first set of retention tabs positioned within the blade housing and connected to the base plate. The retention tabs are configured to engage with the non-cutting edges of the blades. The actuator also includes a locking arm connected to the second surface of the base plate. The locking arm extends laterally downward from the base plate to an unattached arm end. The arm end is configured to be resiliently movable from a first arm position to a second arm position. When the arm end is in the first arm position, the arm end is configured to engage against a supporting rim of the razor cartridge to lock the actuator in the latched position and to enable the retention tabs to hold the blades in the shaving position. When the arm end is in the second arm position, the arm end is configured to disengage from the supporting rim to enable the actuator to be moved to the unlatched position and to enable the retention tabs to move the blades to the cleaning position.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits and advantages described herein.

### BRIEF DESCRIPTION OF THE DRAWINGS

The accompanying drawings, which are incorporated in and constitute a part of the specification, illustrate embodiments of the disclosure and together with the detailed description herein, serve to explain the principles of the disclosure. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the disclosure:

FIG. 1 is a perspective view of a razor cartridge, with the blades in a first shaving position, according to aspects described herein;

FIG. 2 is a perspective view of the razor cartridge of FIG. 1, with the blades in a cleaning position, according to aspects described herein;

FIG. 3 depicts an enlarged perspective view of a razor blade of the razor cartridge of FIG. 1, according to aspects described herein;

FIG. 4 is an enlarged perspective view of the circle A of the razor cartridge of FIG. 1, according to aspects described herein;

FIG. 5 is a side view with a sidewall removed of the razor cartridge of FIG. 1, with the blades in the first shaving position, according to aspects described herein;

FIG. 6 is a side view with a sidewall removed of the razor cartridge of FIG. 1, with the blades in the cleaning position, according to aspects described herein;

FIG. 7 is another example of a perspective view of a razor cartridge, according to aspects described herein;

FIG. 8 is an enlarged perspective view of a razor blade of the razor cartridge of FIG. 7, according to aspects described herein;

FIG. 9 is a side view with a sidewall removed of the razor cartridge of FIG. 7, with the blades in the first shaving position, according to aspects described herein;

FIG. 10 is a side view with a sidewall removed of the razor cartridge of FIG. 7, with the blades are in the cleaning position, according to aspects described herein;

FIG. 11 is another example of a perspective view of a razor cartridge, according to aspects described herein;

FIG. 12 is a perspective side view with a sidewall removed of the razor cartridge of FIG. 11, with the blades are in the first shaving position, according to aspects described herein;

FIG. 13 is a perspective opposing side view with a sidewall removed of the razor cartridge of FIG. 11, with the blades are in the cleaning position, according to aspects described herein;

FIG. 14 is a perspective bottom view of the razor cartridge of FIG. 11, with the blades in the shaving position, according to aspects described herein;

FIG. 15 is a side view with a sidewall removed of the razor cartridge of FIG. 11, with the blades in the first shaving position, according to aspects described herein; and FIG. 16 is a side view with a sidewall removed of the razor cartridge of FIG. 11, with the blades are in the cleaning position, according to aspects described herein.

FIG. 17 is a perspective view of another razor cartridge attached to a handle, according to aspects described herein;

FIG. 18 is an exploded view of the razor cartridge and handle of FIG. 17, according to aspects described herein;

FIG. 19A is an example of a perspective view of the blade housing, with ghosted blades disposed therein, of the razor cartridge of FIG. 17, according to aspects described herein;

FIG. 19B is a rear view of the blade housing, with ghosted blades disposed therein, of the razor cartridge of FIG. 17, according to aspects described herein;

FIG. 19C is a side view of the blade housing, with ghosted blades disposed therein, of the razor cartridge of FIG. 17, according to aspects described herein;

FIG. 20A is a perspective view of the actuator of the razor cartridge of FIG. 17, according to aspects described herein;

FIG. 20B is a side view of the actuator of the razor cartridge of FIG. 17, according to aspects described herein;

FIG. 20C is a rear view of the actuator of the razor cartridge of FIG. 17, according to aspects described herein;

FIG. 21 is a perspective view of the actuator assembled to a ghosted view of the blade housing of the razor cartridge of FIG. 17, according to aspects described herein;

FIG. 22 is a perspective view of an end cap of the razor cartridge of FIG. 17, according to aspects described herein;

FIG. 23A is a side view of the razor cartridge of FIG. 17, with one end cap removed, in the latched position, according to aspects described herein; and

FIG. 23B is a side view of the razor cartridge of FIG. 17, with one end cap removed, in the unlatched position, according to aspects described herein.

### DETAILED DESCRIPTION FOR CARRYING OUT THE INVENTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

The terms “significantly”, “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

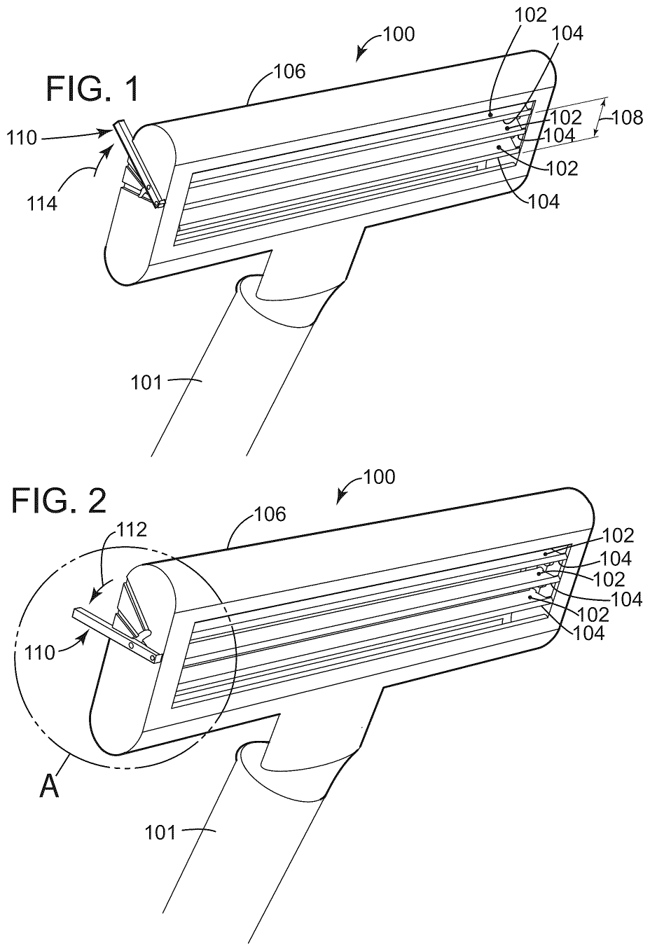

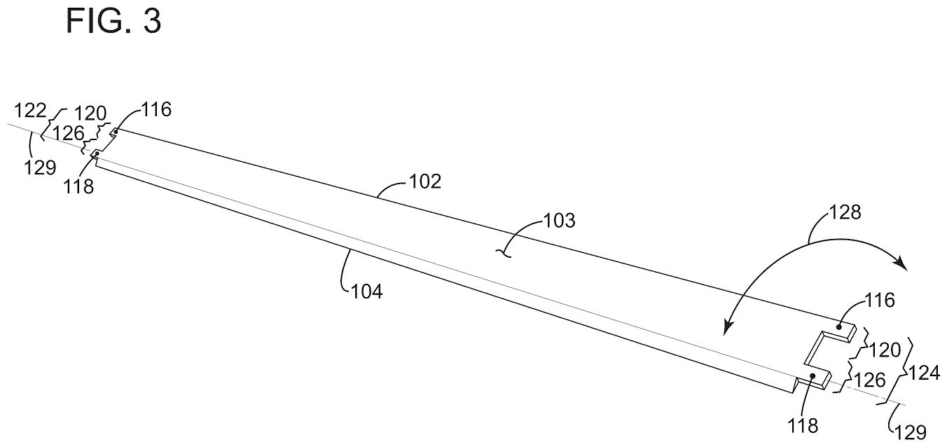

Referring to FIGS. 1 and 2, a perspective view of an example of a razor cartridge 100 is depicted, wherein the blades are in a first shaving position (FIG. 1) and in a cleaning position (FIG. 2), according to aspects described herein. The razor cartridge 100 may be removably attached to a handle 101. The razor cartridge includes a plurality of parallel blades 102. Each blade 102 includes opposing (i.e., front and rear) longitudinal side surfaces 103 and a longitudinal cutting edge 104 (see FIG. 3). The razor cartridge 100 also includes a blade housing 106 that is configured to accommodate the plurality of blades 102. The blades 102 are positioned longitudinally across the blade housing 106, wherein the cutting edges 104 of the blades 102 form a shaving plane 108.

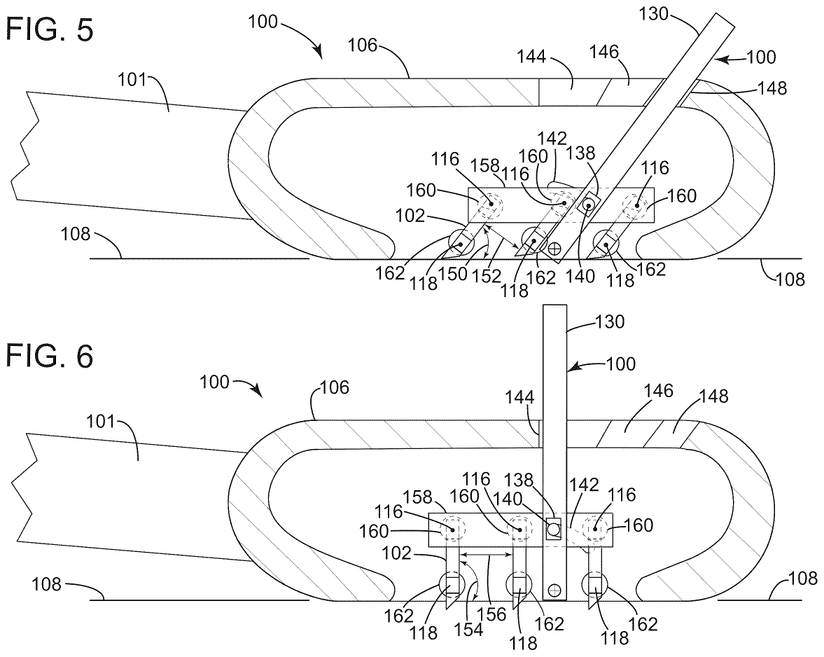

The razor cartridge 100 also includes a shifting mechanism 110 that is configured to rotate (as indicated by directional arrows 112 and 114) the plurality of blades between a first shaving position (FIG. 1) and a cleaning position (FIG. 2). As will be explained in greater detail herein, when the blades 102 are in the first shaving position (FIG. 1), the blades 102 are each oriented at an acute first shaving angle 150 (see FIG. 5) relative to the shaving plane 108 and the blades 102 are each spaced apart a first shaving distance 152 measured perpendicularly between longitudinal side surfaces 103 of two adjacent blades 102. When the blades 102 are in the cleaning position (FIG. 2) the blades 102 are each oriented at a cleaning angle 154 (see FIG. 6) relative to the shaving plane 108 and the blades 102 are each spaced apart a cleaning distance 156 measured perpendicularly between longitudinal side surfaces 103 of two adjacent blades 102.

In FIGS. 1 and 2 and in other FIGS. herein, the shifting mechanism 110 is illustrated as being contained almost entirely within the blade housing 106 of the razor cartridge 100. However, the shifting mechanism 110 may also be housed at least partially within the handle 101 as well.

Advantageously, the cleaning angle 154 is larger than the first shaving angle 150 and the cleaning distance 156 is larger than the first shaving distance 152. The larger cleaning angle 154 and cleaning distance 156 between blades 102 enables a more thorough rinsing of trapped residue (such as hair, creams, lotions or the like) from between the blades 102. Accordingly, the cutting edges 104 of the blades 102 corrode less and last longer.

Referring to FIG. 3, an enlarged perspective view of a razor blade 102 of the razor cartridge 100 is depicted, according to aspects described herein. Each blade 102 of the plurality of blades 102 in the razor cartridge 100 has a control tooth 116 disposed on a first end portion 120 of a first distal end 122 of the blade 102. Each blade 102 may also have a control tooth 116 disposed on a first end portion 120 of a second distal end 124 of the blade 102. The control teeth 116 are configured to engage with the shifting mechanism 110.

Each blade 102 of the plurality of blades 102 also has an axle tooth 118 disposed on a second end portion 126 of the first distal end 122 of the blade 102. Each blade 102 may also have an axle tooth 118 disposed on a second end portion 126 of the second distal end 124 of the blade 102. The axle teeth are configured to pivotally engage with the blade housing 106.

Each blade of the plurality of blades also includes opposing longitudinal side surfaces 103. In other words, each blade includes a longitudinal side surface 103 on its front side (see FIG. 3) and an opposing longitudinal side surface 103 (not shown) on its rear side.

When the shifting mechanism 110 rotates the plurality of blades 102 between the first shaving position (FIG. 1) and the cleaning position (FIG. 2), the shifting mechanism 110 moves the control teeth 116 of each blade 102 arcuately (as indicated by directional arrow 128) between the first shaving position and the cleaning position while the axle teeth of each blade 102 pivots on an axis of rotation 129 of each blade 102.

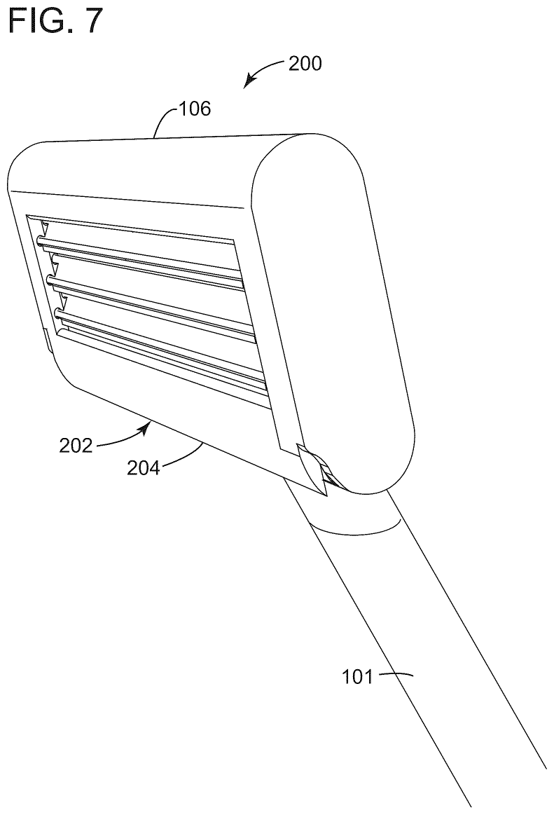

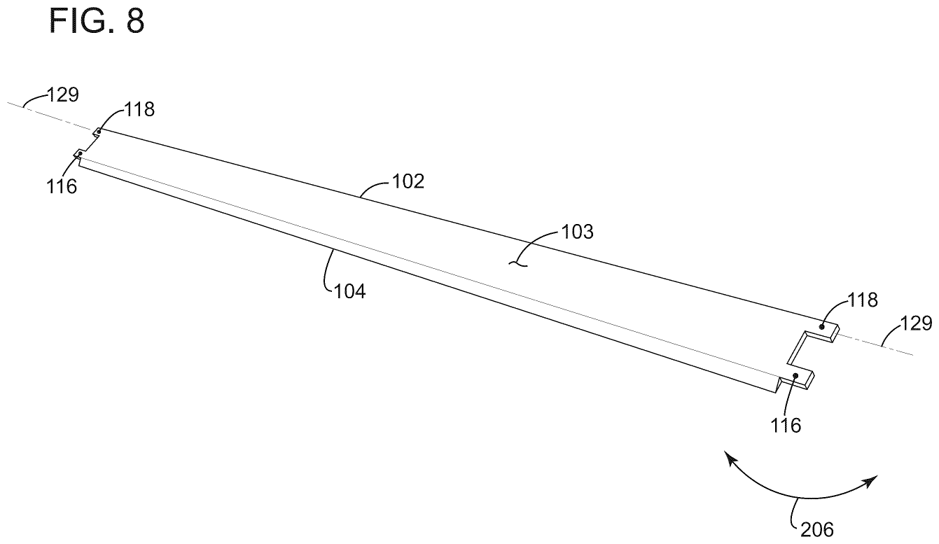

In this example, the axis of rotation 129 for this shifting mechanism 110 passes through the teeth 118 that are closest to the cutting edge 104 and the control teeth 116 are on the opposing side of the cutting edge 104. However, as will be seen in FIG. 8, the axis of rotation 129 for some shifting mechanisms (for example, shifting mechanism 202 of FIGS. 7-10) may pass through the teeth 118 that are on the opposing side of the cutting edge 104 and the control teeth 116 are closest to the cutting edge 104.

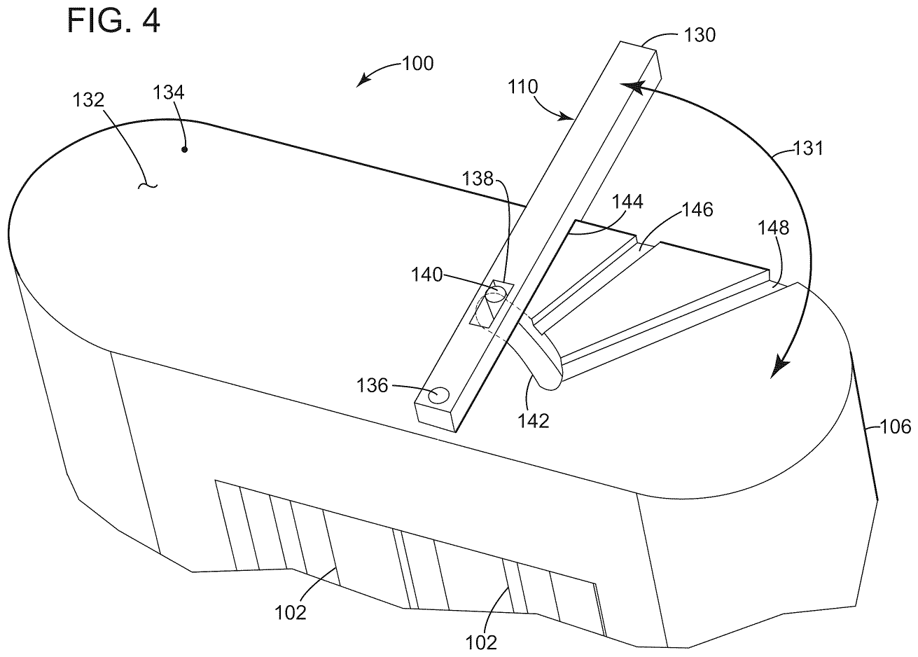

Referring to FIG. 4, an enlarged perspective view is depicted of the circle A in FIG. 1 of the razor cartridge 100, according to aspects described herein. The shifting mechanism 110 of cartridge 100 includes a rotation handle 130 pivotally mounted at pivot point 136 on an outer surface 132 of a sidewall 134 of the blade housing 106. As will be explained in greater detail herein, the rotation handle 130 is operably connected to the control teeth 116 of the blades 102 to enable the handle 130 to rotate (as indicated by directional arrow 131) the blades 102 between the first shaving position (see FIG. 5) and the cleaning position (see FIG. 6).

The rotation handle 130 also includes a connecting pin guide slot 138 extending along a length of the handle 130. As will be explained in greater detail herein, the guide slot 138 is configured to receive a connecting pin 140 that extends outwardly from a blade rotating bar 158 (see FIGS. 5 and 6). The connecting pin 140 extends through a pin guide channel 142 that is disposed in the sidewall 134 of the blade housing 106 and into the pin guide slot 138 of the handle 130.

A first shaving handle seat 148 is disposed in the outer surface 132 of the sidewall 134 of the blade housing 106. The first shaving handle seat 148 is configured to receive the handle 130 therein, when the plurality of blades 102 are in the first shaving position (see FIG. 5). A cleaning handle seat 144 is disposed in the outer surface 132 of the sidewall 134 of the blade housing 106. The cleaning handle seat 144 is configured to receive the handle 130 therein, when the plurality of blades 102 are in the cleaning position (see FIG. 6). Moreover, a second handle seat 146 may be disposed in the outer surface 132 of the sidewall 134 of the blade housing 106 between the first handle seat 148 and the cleaning handle seat 144. The second handle seat 146 may be configured to receive the handle 130 therein, when the plurality of blades 102 are in a second shaving position (not shown).

Referring to FIGS. 5 and 6, a side view, with the sidewall 134 removed, of the razor cartridge 100 is depicted, wherein the blades 102 are in the first shaving position (FIG. 5) and the blades 102 are in the cleaning position (FIG. 6), according to aspects described herein. The shifting mechanism 110 is configured to rotate the plurality of blades 102 between the first shaving position (FIG. 5), wherein the handle 130 is in the first shaving handle seat 148, and the cleaning position (FIG. 6), wherein the handle 130 is in the cleaning handle seat 144. The shifting mechanism 110 may also be configured to rotate the plurality of blades 102 into and out of the second shaving position 146 (not shown), wherein the handle 130 is in the second shaving handle seat 146.

When the blades 102 are in the first shaving position (FIG. 5), the blades 102 are each oriented at an acute first shaving angle 150 relative to the shaving plane 108. Additionally, the blades 102 are each spaced apart a first shaving distance 152 measured perpendicularly between longitudinal side surfaces 103 of two adjacent blades 102. When the blades 102 are in the cleaning position (FIG. 6) the blades 102 are each oriented at a cleaning angle 154 (see FIG. 6) relative to the shaving plane 108 and the blades 102 are each spaced apart a cleaning distance 156

Advantageously, the cleaning angle 154 is larger than the first shaving angle 150 and the cleaning distance 156 is larger than the first shaving distance 152. The larger cleaning angle 154 and cleaning distance 156 between blades 102 enables a more thorough rinsing of trapped residue (such as hair, creams, lotions or the like) from between the blades 102. Accordingly, the cutting edges 104 of the blades 102 corrode less and last longer. By way of example, the cleaning angle 154 may be substantially between 80 and 110 degrees and the first shaving angle 150 may be substantially between 30 and 60 degrees.

Moreover, when the blades 102 are in the second shaving position (not shown), the blades 102 are each oriented at an acute second shaving angle (not shown) relative to the shaving plane 108 and the blades are each spaced apart a second shaving distance (not shown) measured perpendicularly between longitudinal side surfaces 103 of two adjacent blades 102. In the second shaving position, the second shaving angle would be larger than the first shaving angle 150 and smaller than the cleaning angle 154. Also, in the second shaving position, the second shaving distance would be larger than the first shaving distance 152 and smaller than the cleaning distance 156.

As described earlier, the shifting mechanism 110 includes the rotation handle 130 pivotally mounted on an outer surface 132 of a sidewall 134 of the blade housing (see FIG. 4). The rotation handle 130 includes the connecting pin guide slot 138 extending along a length of the handle. The shifting mechanism 110 also includes a blade rotating bar 158 disposed within the blade housing 106, which is configured to be moved laterally along the blade housing 106. The blade rotating bar 158 includes a plurality of control tooth thru-holes 160. Each control tooth thru-hole 160 configured to receive a control tooth 116 of each blade 102 therethrough. The blade rotating bar 158 includes the connecting pin 140 extending outwardly from the blade rotating bar 158. The connecting pin 140 extends through the pin guide channel 142 (see FIG. 4) disposed in the sidewall 134 of the blade housing 106 and into the pin guide slot 138 of the handle 130.

The shifting mechanism 110 also includes a plurality of axis of rotation holes 162 disposed in the inner surface of the sidewall 134. Each axis of rotation hole 162 is configured to receive an axle tooth 118 of each blade 102 therein.

During operation, when the handle 130 is pivoted from the first shaving handle seat 148 to the cleaning handle seat 144, the connecting pin guide slot 138 of the handle 130 urges the connecting pin 140 to move arcuately along the pin guide channel 142 in the sidewall 134 of the blade housing 106. The connecting pin 140 urges the blade rotating bar 158 to move laterally within the blade housing 106. As the blade rotating bar 158 moves laterally, the plurality of control tooth thru-holes 160 of the blade rotating bar 158 urge each control tooth 116 of each blade 102 to move arcuately and to pivot the plurality of blades 102 from the shaving position (FIG. 5) to the cleaning position (FIG. 6).

Only a first shaving position and a cleaning position of the blades 102 have been illustrated herein. However, there may be any number of shaving positions (for example a second shaving position or a third shaving position) of the blades in between the first shaving position and the cleaning position. Advantageously, by providing a plurality of shaving positions, the varying shaving angles of the razor blades 102 allow a user to adjust for various levels of closeness of shaves and lengths of shaves.

The shaving mechanism only illustrates a blade rotating bar 158 disposed on one side of the blade housing 106 to engage with the control tooth 116 and axle tooth 118 of the first distal ends 122 of the blades 102. However, there may also be a second blade rotating bar disposed on the opposing side of the blade housing 106 to engage with the control tooth 116 and axle tooth 118 on the second distal ends 124 of the blades 102.

Referring to FIG. 7, a perspective view of another example of a razor cartridge 200 is depicted, according to aspects described herein. Razor cartridge 200 has many features that are similar or substantially the same to that of razor cartridge 100, wherein such substantially same or similar features will be referenced with the same reference numbers.

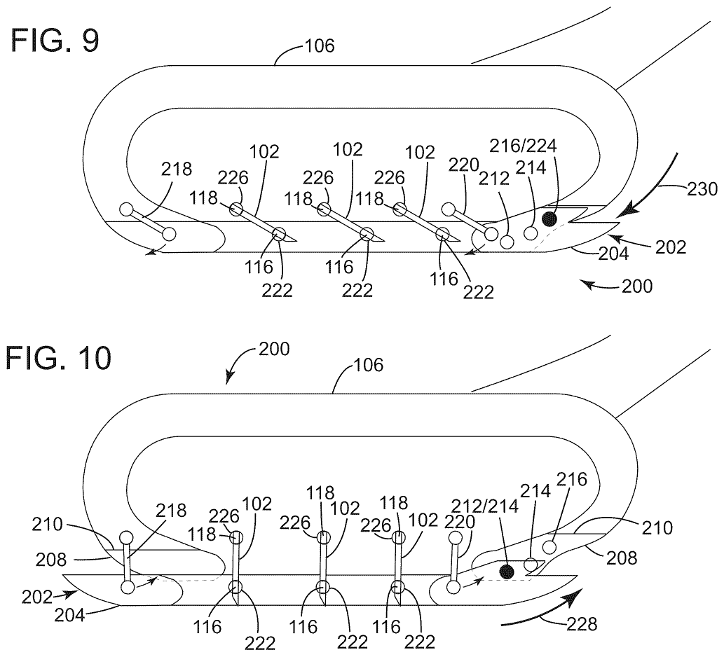

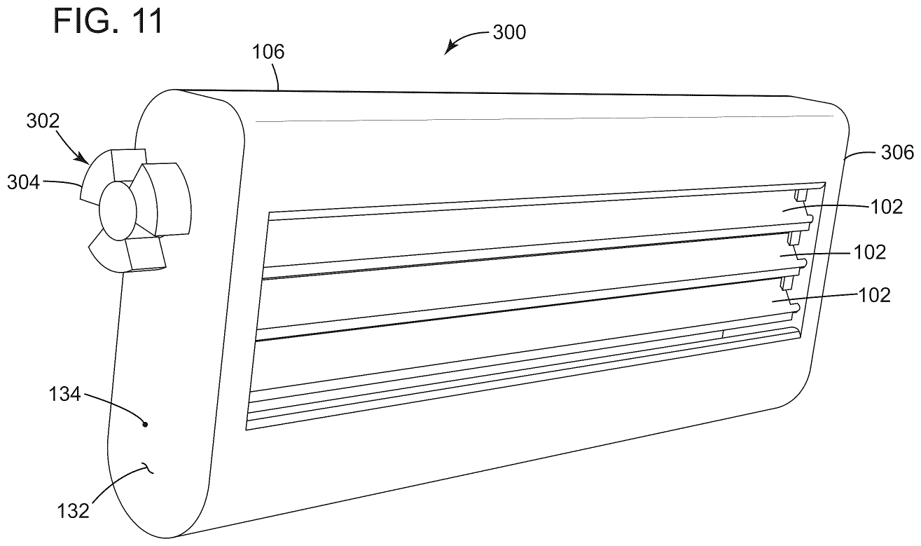

The shift mechanism 202 of razor cartridge 200 includes a face frame 204 that is pivotally connected to an open bottom 210 the blade housing 106. The face frame 204 is configured to be pivoted from a first lock position (FIG. 9) to a down position (FIG. 10) in order to move the blades 102 from a first shaving position (FIG. 9) to a cleaning position (FIG. 10).

Referring to FIG. 8, an enlarged perspective view of a razor blade 102 of the razor cartridge 200 is depicted, according to aspects described herein. The blade 102 of cartridge 200 is substantially the same as blade 102 of cartridge 100, except that the control tooth 116 is closest to the cutting edge 104 of the blade 102 and the axle tooth 118 is on the side opposite the cutting edge 104. Therefore, in the shift mechanism 202 of the razor cartridge 200, the axis of rotation 129 passes through the control teeth 118 that are on the opposing side of the cutting edge 104 and the control teeth 116, which are closest to the cutting edge 104, are moved arcuately (as indicated by arrow 206) by the shifting mechanism 202.

Referring to FIGS. 9 and 10, a side view with a sidewall removed of the razor cartridge 200 is depicted, wherein the blades are in the first shaving position (FIG. 9) and the blade are in the cleaning position (FIG. 10), according to aspects described herein.

The shifting mechanism 202 of razor cartridge 200 includes a lock base 208 disposed on a peripheral portion of an open bottom 210 of the blade housing 106. The lock base 208 having a cleaning lock seat 212 and a first shaving lock seat 216 and a second shaving lock seat 214 disposed thereon.

The face frame 204 of the shifting mechanism 202 is pivotally connected to the open bottom 210 of the blade housing 106 by a first spring loaded hinge 218 and a second spring loaded hinge 220. The face frame 204 is configured to be pivoted on the first and second hinges 218, 220 from a first lock position (FIG. 9) to a down position (FIG. 10). When the face frame 202 is in the first lock position, the blades 102 are in the first shaving position. When the face frame 202 is in the down position, the blades 102 are in the cleaning position.

The face frame 202 includes a plurality of control tooth holes 222 configured to receive each control tooth 116 of each blade 102 therein. The face frame 202 also includes a lock pin 224 (shown in black) configured to engage with the cleaning lock seat 212 and the first and second shaving lock seats 216, 214.

The shifting mechanism 202 also includes a plurality of axis of rotation holes 226 disposed in the inner surface of a sidewall (not shown) of the blade housing 106. Each axis of rotation hole 226 is configured to receive an axle tooth 118 of each blade 102 therein.

During operation, when the face frame 204 is pushed upward (as indicated by directional arrow 228 of FIG. 10) into the first lock position (FIG. 9), the lock pin 224 (shown in black) is moved to engage with the first shaving lock seat 216 and the plurality of blades 102 are rotated into the first shaving position. When the face frame 204 is pushed downward (as indicated by directional arrow 230 of FIG. 9) into the down position, the lock pin 224 is moved to engage with the cleaning lock seat 212 and the plurality of blades 102 are rotated into the cleaning position.

Moreover, the second lock seat 214 disposed in the lock base 208 between the cleaning lock seat 212 and the first lock seat 216. The second lock seat 214 is also configured to receive the lock pin 224 therein. When the lock pin 224 is in the second lock seat 214 (not shown), the plurality of blades 102 are in a second shaving position (not shown).

Only a first shaving position (FIG. 9) and a cleaning position (FIG. 10) of the blades 102 have been illustrated herein. However, there may be any number of shaving positions (for example a second shaving position or a third shaving position) of the blades in between the first shaving position and the cleaning position.

Referring to FIG. 11, a perspective view of another example of a razor cartridge 300 is depicted, according to aspects described herein. Razor cartridge 300 has many features that are similar or substantially the same to that of razor cartridge 100 and 200, wherein such substantially same or similar features will be referenced with the same reference numbers.

The shift mechanism 302 of razor cartridge 300 includes a wheel 304 rotationally mounted on the outer surface 132 of the first sidewall 134 of the blade housing 106. The blades 102 in FIG. 11 are shown in the first shaving position and extend from the first sidewall 134 to a second opposing sidewall 306.

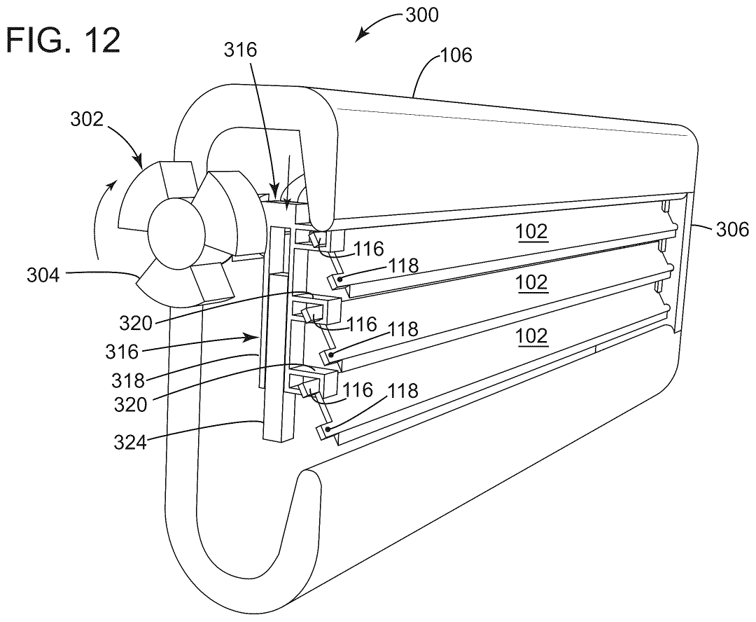

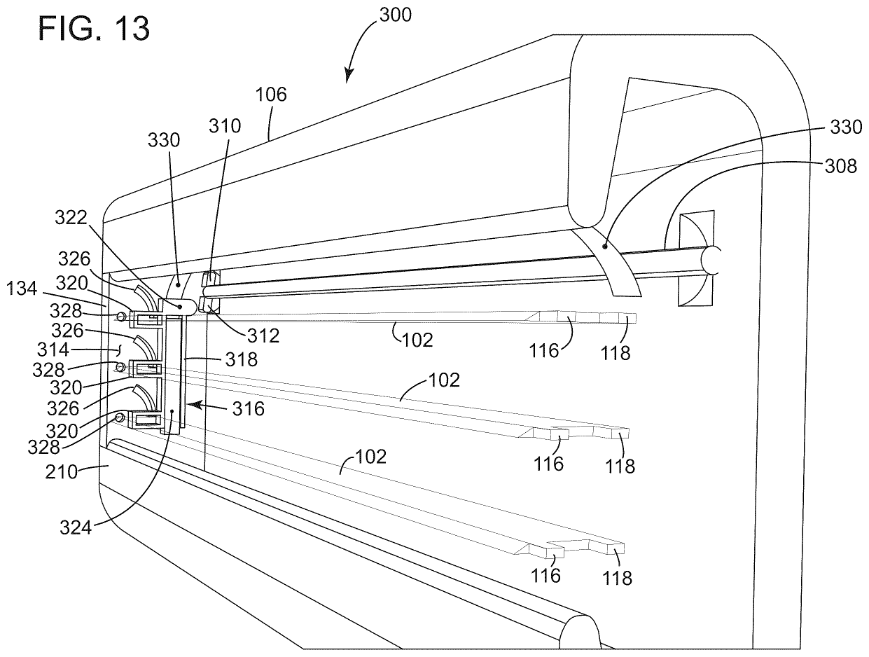

Referring to FIGS. 12 and 13, a perspective side view with the sidewall 134 removed of the razor cartridge 300 is depicted (FIG. 12), and a perspective opposing side view with the opposing sidewall 306 removed of the razor cartridge 300 (FIG. 13) is depicted. The blades 102 of FIG. 12 are depicted in the first shaving position. The blades 102 of FIG. 13 are depicted in the cleaning position.

The shift mechanism 302 of razor cartridge 300 also includes a shaft 308 that is connected centrally to the wheel 304 and rotatable by the wheel 304. The shaft extends longitudinally through the blade housing 106.

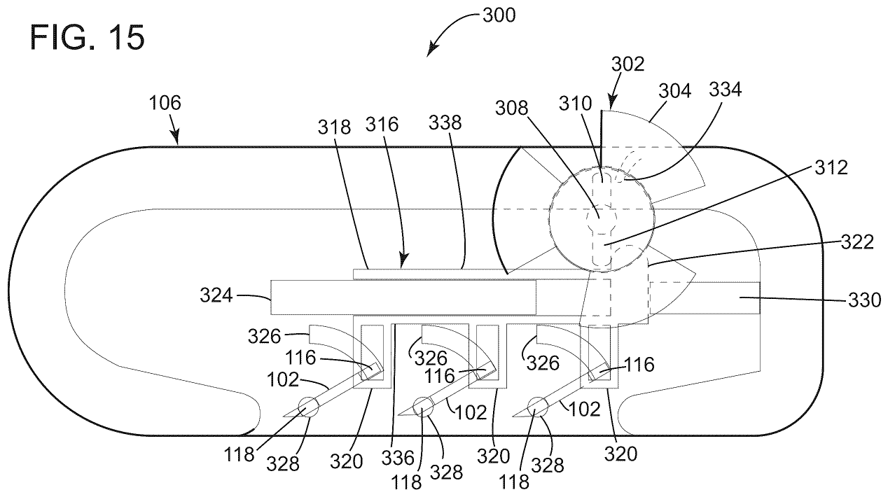

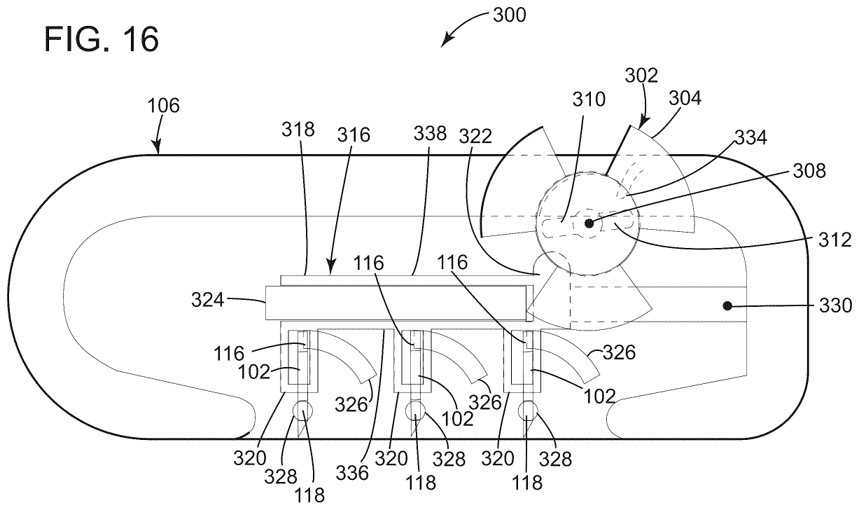

The shift mechanism 302 also includes a first gear tooth 310 (see also FIGS. 15 and 16) and an opposing second gear tooth 312 (see also FIGS. 15 and 16) extend radially outward from the shaft 308 at substantially 180 degrees from each other. The first gear tooth 310 and the second gear tooth 312 are positioned proximate an inner surface 314 of the first sidewall 134 of the blade housing 106.

The shift mechanism 302 further includes a first slide bar 316 positioned below the shaft 308 and between the shaft 308 and the blade housing open bottom 210. The first slide bar 316 includes a slide bar body 318, a plurality of control tooth tracks 320 and a slide tooth 322.

The slide bar body 318 is configured to slide laterally along a slide track 324 that is attached to the blade housing 106. The plurality of control tooth tracks 320 extend downward from a longitudinal side 336 (see FIGS. 15 and 16) of the slide bar body 318. Each control tooth track 320 is configured to receive a control tooth 116 of each blade 102 therethrough. The slide tooth 322 extend upward from a longitudinal opposing side 338 (see FIGS. 15 and 16) of the slide bar body 318. The slide tooth 322 is configured to engage with the first and second gear teeth 310, 312.

The shift mechanism 302 also includes a locking pin 334 (see FIGS. 15 and 16). The locking pin 334 is positioned above the shaft 308. The locking pin 334 is configured to engage with the first and second gear teeth 310, 312.

The shift mechanism additionally includes a plurality of control tooth channels 326, a plurality of axis of rotation holes 328 and a spring bar 330. The plurality of control tooth channels 326 are disposed in the inner surface 314 of the first sidewall 134. Each control tooth channel 326 is configured to receive a control tooth 116 of each blade 102 therein, after the control tooth 116 has extended through its associated control tooth track. The plurality of axis of rotation holes 328 are also disposed in the inner surface of the sidewall. Each axis of rotation hole 328 is configured to receive an axle tooth 118 of each blade 10 therein.

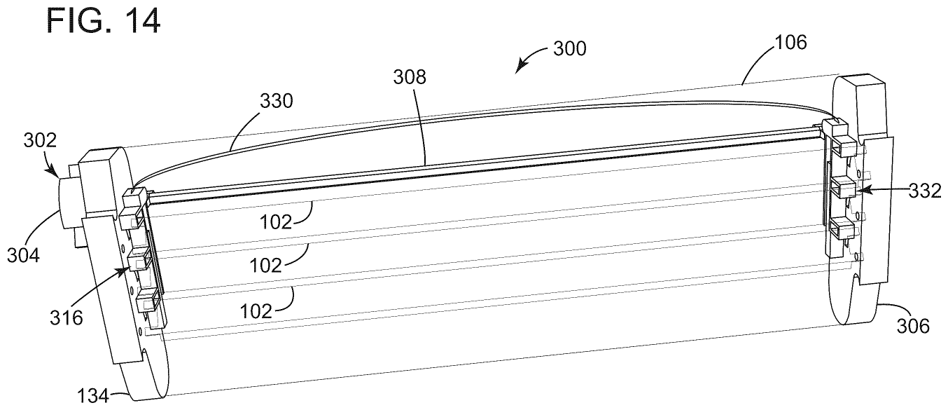

Referring to FIG. 14, a perspective bottom view of the razor cartridge 300 is depicted, wherein the spring bar 330 is shown extending between the first slide bar 316 and a second slide bar 332 disposed on the second sidewall 306, according to aspects described herein. The spring bar 330 is configured to engage with a distal end of the first slide bar 316 on sidewall 134 and may engage with a distal end of a second slide bar 332 on the opposing sidewall 306.

The spring bar 330 extends arcuately across the length of the blade housing 106. As will be discussed in greater detail herein, the spring bar engages with the first slide bar 316 to bias the blades 102 into the cleaning position.

Though the spring bar 330 is shown herein as a bar that extend arcuately across the length of the blade housing 106, other forms of springs may also be used to bias the first slide bar 316 or second slide bar 332. For example, a coiled compression spring may be disposed on the distal ends of each slide bar 316, 332.

Additionally, similar structures of those portions of the shifting mechanism 302 that are disposed on or near the sidewall 134 (e.g., the first and second gear teeth 310, 312, the first slide bar 316, the control tooth channels 326 and the axis of rotation holes 328) may also be disposed on or near the opposing sidewall 306. By doing so, shifting of the blades 102 from the shaving position to the cleaning position may be more precisely controlled.

Referring to FIGS. 15 and 16, a side view with the sidewall 134 removed of the razor cartridge 300 is depicted, wherein the blades are in the first shaving position (FIG. 15) and the blade are in the cleaning position (FIG. 16), according to aspects described herein.

As discussed earlier, the shift mechanism 302 includes the wheel 304 rotationally mounted on the outer surface 132 (see FIG. 11) of the first sidewall 134 (see FIG. 11) of the blade housing 106. The shaft 308 is connected centrally to the wheel 304 and rotatable by the wheel 304. The shaft 308 extends longitudinally through the blade housing 106 (see FIG. 13).

The first gear tooth 310 and the opposing second gear tooth 312 extend radially outward from the shaft 308 at substantially 180 degrees from each other. The first gear tooth 310 and the second gear tooth 312 being positioned proximate an inner surface 314 (see FIG. 13) of the first sidewall 134 of the blade housing 106.

The shift mechanism 302 also includes the first slide bar 316, which is positioned below the shaft 308. The first slide bar 316 includes the slide bar body 318, a plurality of control tooth tracks 320 and a slide tooth 322. The slide bar body 318 is configured to slide laterally along a slide track 324 that is attached to the blade housing 106. The plurality of control tooth tracks 320 extend downward from the longitudinal side 336 of the slide bar body 318, each control tooth track 320 is configured to receive a control tooth 116 of each blade 102 therethrough. The slide tooth 322 extends upward from the opposing longitudinal side 338 of the slide bar body 318. The slide tooth 322 is configured to engage with the first and second gear teeth 310, 312.

The locking pin 334 is positioned above the shaft 308, opposite the slide tooth 322. The locking pin 334 is configured to engage with the first and second gear teeth 310, 312.

The plurality of control tooth channels 326 are disposed in the inner surface 314 (see FIG. 13) of the first sidewall 134 (see FIG. 13). Each control tooth channel 326 is configured to receive a control tooth 118 of each blade 102 therein, after the control tooth 118 extends through it associated slide track 324. The plurality of axis of rotation holes 328 are also disposed in the inner surface 314 of the sidewall 134. Each axis of rotation hole 328 is configured to receive an axle tooth 118 of each blade 102 therein.

The spring bar 330 of shifting mechanism 302 is configured to engage with a distal end of the first slide bar 316. The spring bar 330 biases the blades 102 toward the cleaning position (FIG. 16).

The shifting mechanism 302 includes a locked position (FIG. 15) and an unlocked position (FIG. 16) When the shifting mechanism 302 is in the locked position (FIG. 15):
One of the first or second gear teeth 310, 312 is engaged against the slide tooth 322 to urge the first slide bar 316 against the spring bar 330 and compress the spring bar 330 into a compressed position. In FIG. 15, the second gear tooth 312 is shown engaging the slide tooth 322.

The other of the first and second gear teeth 310, 312 is engaged against the locking pin 334 to prevent the compressed spring bar 330 from rotating the wheel 334 in a clockwise direction and moving the first slide bar 316 laterally along the slide track 324.

The control teeth 116 of each of the blades 102 are positioned by the plurality of control tooth tracks 320 and control tooth channels 326 such that the blades 108 are pivoted into the first shaving position (see FIG. 15).

To move to the unlocked position (FIG. 16) of the shift mechanism 302 from the locked position (FIG. 15), the wheel may be rotated manually in a counterclockwise direction. In doing so, the second gear tooth 312 will press against the slide tooth 322 to slightly further compress the spring bar 300, until the second gear tooth 312 clears the apex of the slide tooth 322. Once the second gear tooth 312 has cleared the slide tooth 322 (see FIG. 16), the spring bar 330 is free to extend and urge the first slide bar 316 laterally along the slide track 324 to put the spring mechanism 302 into its unlock position.

When the shifting mechanism 302 is in the unlocked position (FIG. 16):

The first and second gear teeth 310, 312 are disengaged from the slide tooth 322 and the locking pin 334.

The spring bar 330 is extended into an extended position to move the first slide bar 316 laterally along the slide track 324.

The control teeth 116 of each of the blades 102 are positioned by the plurality of control tooth tracks 320 and control tooth channels 326 such that the blades 102 are pivoted into the cleaning position.

To move to back to the locked position (FIG. 15) of the shift mechanism 302 from the unlocked position (FIG. 16), the wheel may be rotated manually further in a counterclockwise direction. In doing so, the first gear tooth engages the slide tooth 322 to push it back and recompress the spring bar 330. The second gear tooth 312 engages the resilient locking pin 334 to compress the locking pin 334 upwards until the second gear tooth 312 clears the apex of the locking pin 334. Once the apex of the locking pin 334 has been cleared, the resilient locking pin 334 returns to its uncompressed position to lock the second gear tooth 312 in place.

The wheel 304 is shown as turning counterclockwise to release the slide tooth 322. However, the shifting mechanism 302 can be configured such that the wheel 304 turns clockwise to release the slide tooth 322.

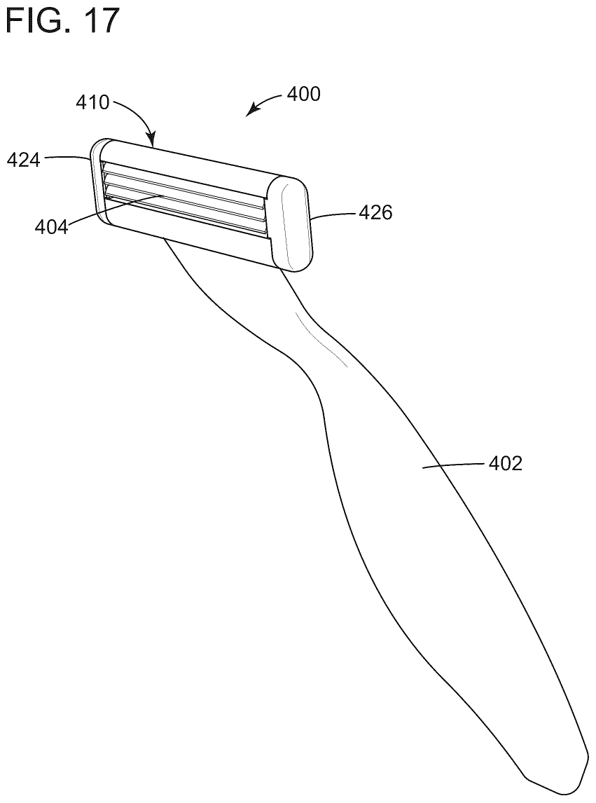

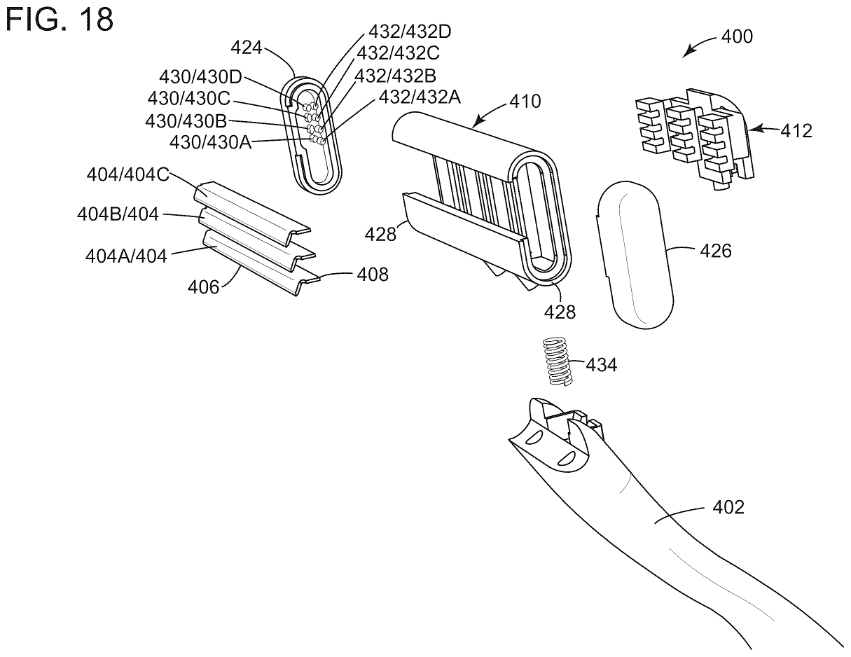

Referring to FIGS. 17 and 18, an example is depicted of a perspective view (FIG. 17) and an exploded view (FIG. 18) of another razor cartridge 400 attached to a handle 402, according to aspects described herein. The razor cartridge 400 includes a plurality of parallel blades 404. In this specific case there are three blade 404A, 404B and 404C (collectively herein “blades 404). Each blade 404 includes a longitudinal cutting edge 406 and an opposing longitudinal non-cutting edge 408. The razor cartridge 400 also includes a blade housing 410 configured to accommodate the plurality of blades 404 therein. The blades 404 are positioned longitudinally across the blade housing 410.

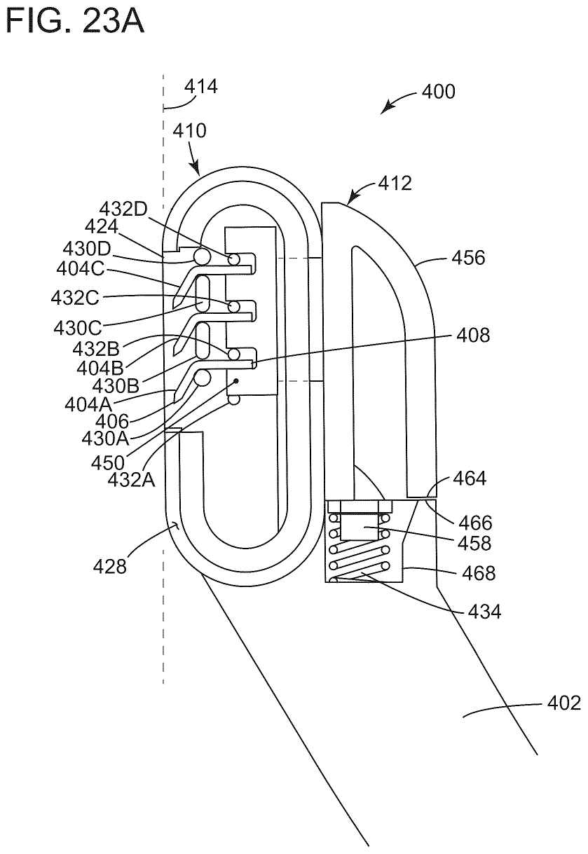

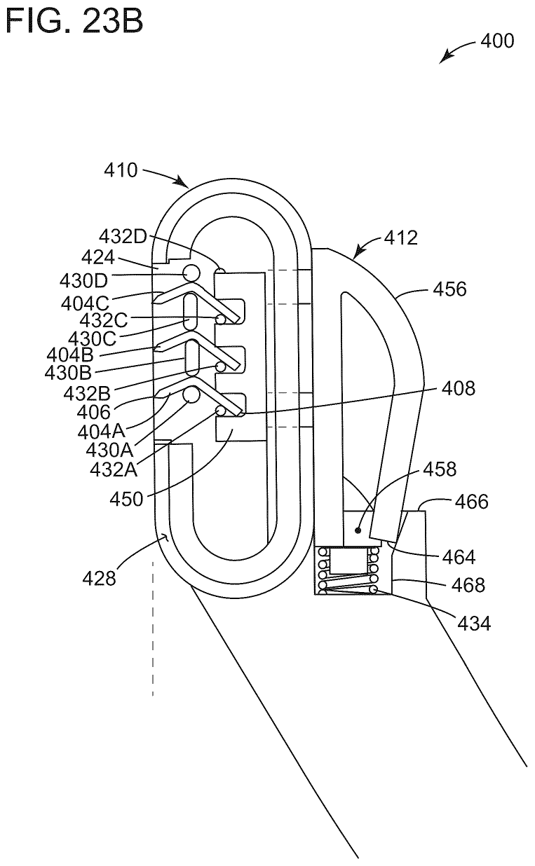

An actuator 412 forms at least a portion of a shifting mechanism that is configured to rotate the plurality of blades 404 between a shaving position of the razor cartridge 400 (see FIG. 23A) and a cleaning position of the razor cartridge 400 (see FIG. 23B). As will be explained in greater detail herein, the actuator is movable between a latched position when the cartridge 400 is in the shaving position (FIG. 23A) and an unlatched position when the cartridge 400 is in the cleaning position (FIG. 23B). Also, as will be explained in greater detail herein, a compression spring 434 continuously urges the actuator 412 toward its latched position.

Similar to earlier examples of razor cartridges (100, 200, 300) presented herein, the cutting edges 406 of the blades 404 may form a shaving plane 414 (see FIG. 23A). In the shaving position FIG. 23A, the blades 404 may each be oriented at a shaving angle 416 (see FIG. 23A) relative to the shaving plane 414 and the blades 404 may each be spaced apart a shaving distance 418 measured perpendicularly between longitudinal side surfaces of two adjacent blades 404. In the cleaning position (FIG. 23B) the blades 404 may each be oriented at a cleaning angle 420 relative to the shaving plane 414 and the blades 404 may each be spaced apart a cleaning distance 422 measured perpendicularly between longitudinal side surfaces of two adjacent blades 404. The cleaning angle 420 may be larger than the shaving angle 416 and the cleaning distance 422 may be larger than the shaving distance 418.

A first end cap 424 and a second end cap 426 are disposed on opposing longitudinal sides 428 of the blade housing 410. As will be explained in greater detail herein, each end cap 424, 426 includes a set of pivot posts 430A, 430B, 430C, 430D (collectively herein “pivot posts 430”). Each end cap 424, 426 also includes a set of stop posts 432A, 432B, 432C, 432D (collectively herein “stop posts 432”).

The set of pivot posts 430 are configured to engage with the blades 404 such that each blade 404 pivots around a respective pivot post 430 as the actuator 412 moves from the latched position to the unlatched position. The set of stop posts 432 are configured to engage with the blades 404 such that the stop posts 432 provide a positive stop for each blade 404 when the blades 404 reach the shaving position (FIG. 23A) and additionally provide a positive stop when the blades 404 reach the cleaning position (FIG. 23B).

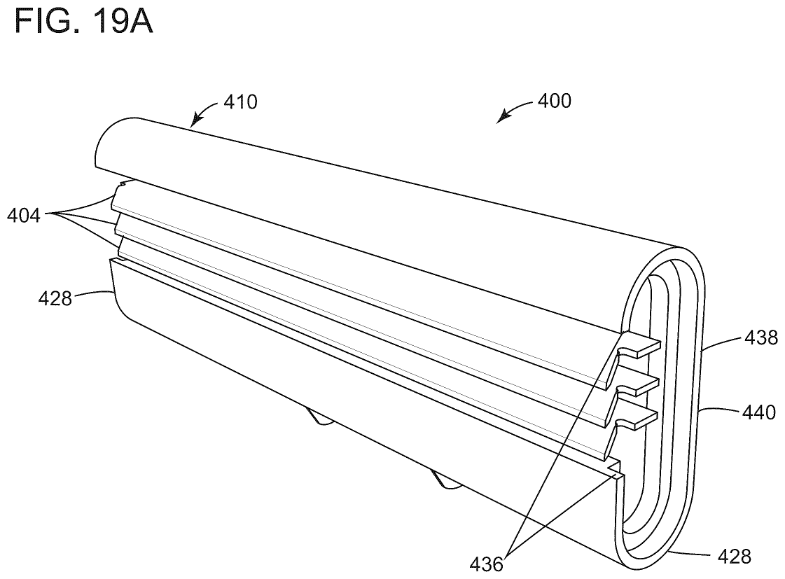

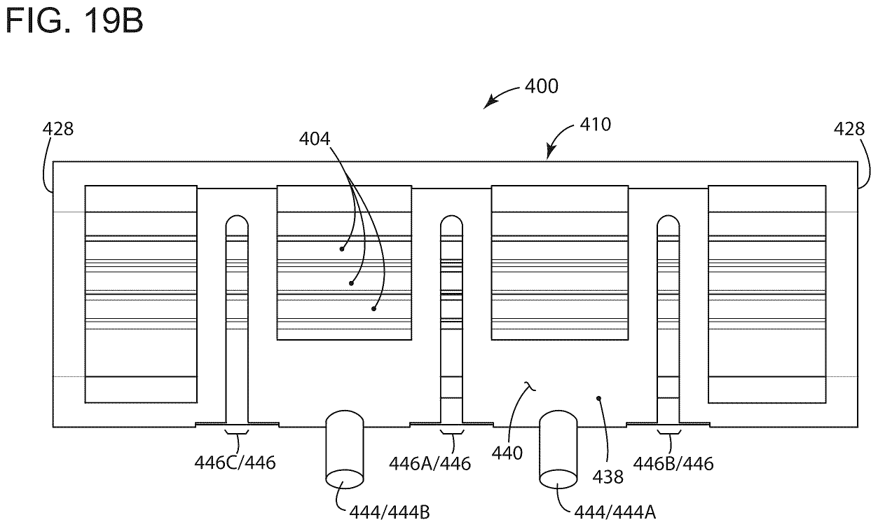

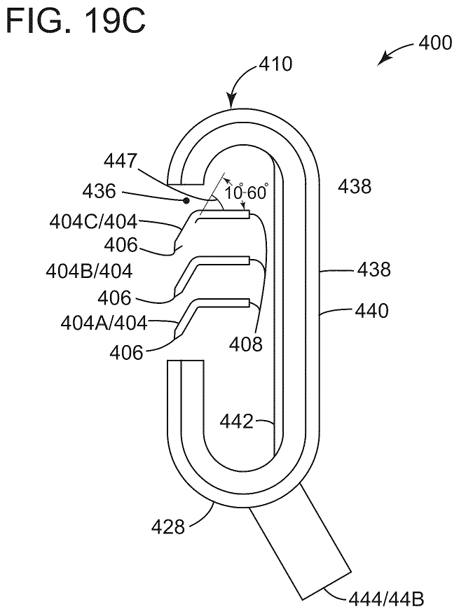

Referring to FIGS. 19A, 19B and 19C, an example is depicted of a perspective view (FIG. 19A), a rear view (FIG. 19B) and a side view (FIG. 19C) of the blade housing 410, with ghosted blades 404 disposed therein, of the razor cartridge 400 of FIG. 17, according to aspects described herein. The blade housing 410 includes a front opening 436 and a rear wall 438. The front opening 436 is configured to enable the cutting edges 406 of the blades 404 to extend therethrough. The rear wall 438 includes an outer surface 440 and an inner surface 442.

A connecting mechanism 444 removably connects the blade housing 410 to the handle 402. In this case, the connecting mechanism 444 comprises a first connecting post 444A and a second connecting post 444B. However, the connecting mechanism 444 may be any appropriate device the removably attach the blade housing 410 to the handle 402.

The blade housing 410 also includes a laterally extending first guide slot 446A positioned centrally in the blade housing 410. The blade housing also includes a laterally extending second guide slot 446B and a laterally extending third guide slot 446C positioned on opposing end portions of the blade housing 410. As will be explained in greater detail herein, the guide slots 446A, 446B, 446C are configured to guide the actuator 412 laterally up and down the rear wall 438 of the blade housing 410 between the latched position (FIG. 23A) and the unlatched position (FIG. 23B).

Referring more specifically to FIG. 19C, the blades 404 may include a blade angle 447. The blade angle 447 can be any appropriate angle, from a zero (0) degree blade angle (i.e., a straight blade) to an angle that is 75 degrees or larger. An example of a range of workable blade angles includes blade angles from substantially 10 degrees to substantially 60 degrees. The blade angle 447 may be used to reduce the size (e.g., height and width) of the blade housing 410.

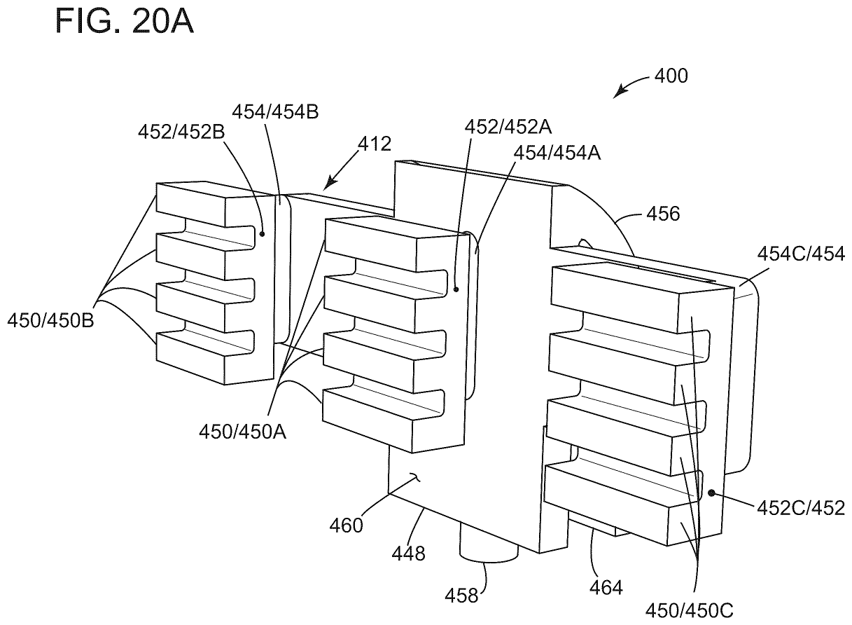

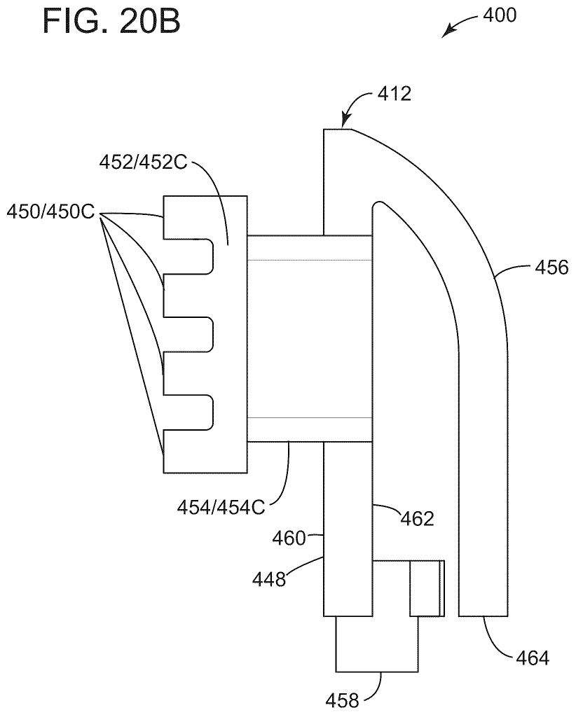

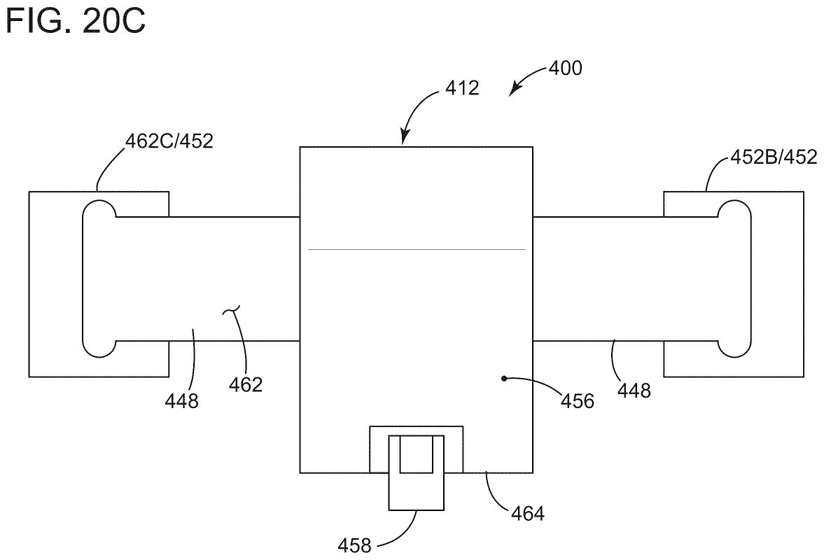

Referring to FIGS. 20A, 20B and 20C, an example is depicted of a perspective view (FIG. 20A), a side view (FIG. 20B) and a rear view (FIG. 20C) of the actuator 412 of the razor cartridge 400 of FIG. 17, according to aspects described herein. The actuator 412, includes a base plate 448, at least a first set of retention tabs 450A disposed on a first tab plate 452A, at least a first plate stem 454A connecting the first tab plate 452A to the base plate 448 and a locking arm 456. The actuator 412 also includes a spring guidepost 458.

The actuator 412 is configured to be movable from a latched position (FIG. 23A) to an unlatched position (FIG. 23B). The actuator 412 includes a base plate 448 having a first surface 460 and an opposing second surface 462. The first surface 460 of the base plate 448 is configured to abut against the outer surface 440 of the rear wall 438 of the housing 410. The base plate 448 is configured to move laterally up and down the rear wall 438 of the housing 410 between the latched position (FIG. 23A) and the unlatched position (FIG. 23B) of the actuator 412. The first set of retention tabs 450A is positioned within the blade housing 410 and connected to the base plate 448. More specifically, the first set of retention tabs 450A are disposed on the first tab plate 452A, and the first plate stem 454A connects the first tab plate 452A to the base plate 448 through the first guide slot 446A of the blade housing 410. The first guide slot 446A guides the actuator base plate 448 laterally up and down as the actuator 412 moves from the latched position (FIG. 23A) to the unlatched position (FIG. 23B).

The actuator 412 may also include multiple sets of retention tabs connected to the base plate 448. In the examples illustrated herein, there are included a first, second and third guide slot 446A, 446B and 446C (collectively herein “guide slots 446”) disposed in the blade guide 410. There are also a first second and third set of retention tabs 450A, 450B, 450C (collectively herein “retention tabs 450”) respectively disposed on a first, second and third tab plate 452A, 452B, 452C (collectively herein “tab plates 452), wherein first, second and third plate stems 454A, 454B, 454C (collectively herein “plate stems 454”) respectively connect the first, second and third tab plates 452A, 452B, 452C to the base plate 448 through the first, second and third guide slots 446A, 446B, 446C.

The retention tabs 450 are configured to engage with the non-cutting edges 408 of the blades 404. The retention tabs 450 rotate the blades 404 from the shaving position (FIG. 23A) to the cleaning position (FIG. 23B) as the actuator moves between the latched position (FIG. 23A) and the unlatched position (FIG. 23B).

The locking arm 456 is connected to the second surface 462 of the base plate 448. The locking arm 456 extends laterally downward from the base plate 448 to an unattached arm end 464. The arm end 464 is configured to be resiliently movable from a first arm position (FIG. 23A) to a second arm position (FIG. 23B). When the arm end 464 is in the first arm position (FIG. 23A), the arm end 464 is configured to engage against a supporting rim 466 of the razor cartridge 400 to lock the actuator 412 in the latched position (FIG. 23A) and to enable the retention tabs 450 to hold the blades 404 in the shaving position (FIG. 23A). When the arm end 464 is in the second arm position (FIG. 23B), the arm end 464 is configured to disengage from the supporting rim 466 to enable the actuator 412 to be moved to the unlatched position (FIG. 23B) and to enable the retention tabs 450 to move the blades 404 to the cleaning position (FIG. 23B).

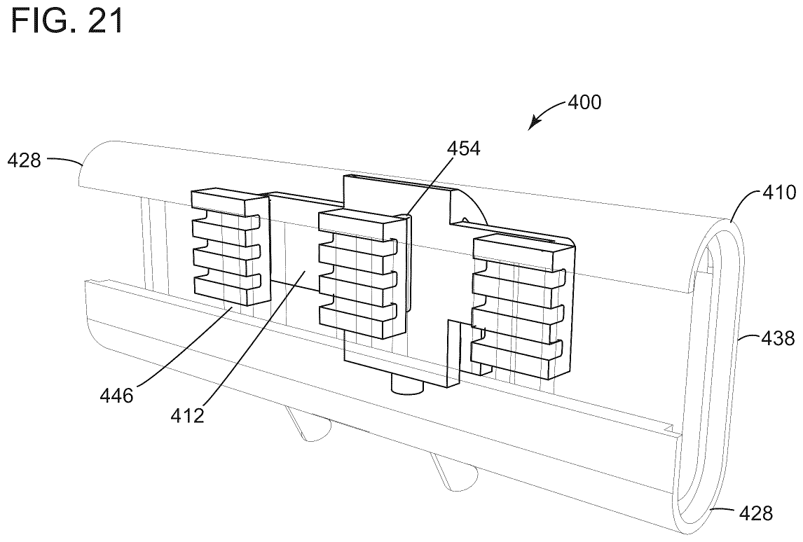

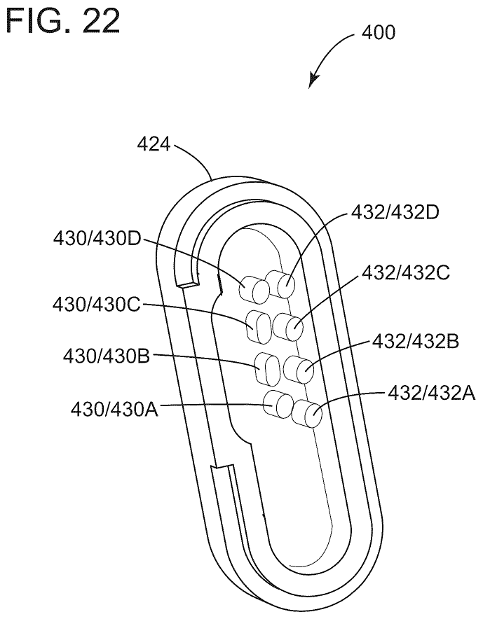

Referring to FIG. 21, an example is depicted of perspective view of the actuator 410 assembled to a ghosted view of the blade housing 412 of the razor cartridge 400 of FIG. 17, according to aspects described herein. As can be more clearly seen in FIG. 21, the plate stems 454 of the actuator 412 extend through the guide slots 446 of the blade housing 410 to slidably affix the actuator 412 to the blade housing 410. The guide slots 446 act as guides to the plate stems 454 to enable the actuator 412 to move laterally up and down the rear wall 438 of the blade guide 410.

Referring to FIG. 22, an example is depicted of a perspective view of the first end cap 424 of the razor cartridge 400 of FIG. 17, according to aspects described herein. Because the first and second end caps 424, 426 are symmetrical, only the first end cap is illustrated herein.

The first and a second end cap 424, 426 are disposed on opposing longitudinal sides 428 of the blade housing 410. Each end cap includes a set of pivot posts 430 and a set of stop posts 432. The set of pivot posts 430 are configured to engage with the distal ends of the blades 404 such that each blade 404 pivots around a respective pivot post 430 as the actuator 412 moves from the latched position (FIG. 23A) to the unlatched position (FIG. 23B). The set of stop posts 432 are configured to engage with the distal ends of the blades 404 such that the stop posts 432 provide a positive stop for each blade 404 when the blades 404 reach the shaving position (FIG. 23A) and when the blades 404 reach the cleaning position (FIG. 23B).

Referring to FIGS. 23A and 23B, an example is depicted of a side view of the razor cartridge 400 of FIG. 17, with the second end cap 426 removed, in the latched position (FIG. 23A) and in the unlatched position (FIG. 23B), according to aspects described herein. In the razor cartridge 400, the first end cap 424 and second end cap 426 (see FIG. 18) are disposed on opposing longitudinal sides 428 of the blade housing 410. Each end cap 424, 426 includes the set of pivot posts 430 and the set of stop posts 432 disposed therein. The set of pivot posts 430 are configured to engage with the opposing distal ends of the blades 404 such that each blade 404 pivots around a respective pivot post 430 as the actuator 412 moves from the latched position (FIG. 23A) to the unlatched position (FIG. 23B). The set of stop posts 432 are configured to engage with the distal ends of the blades 404 such that the stop posts 432 provide a positive stop for each blade 404 when the blades 404 reach the shaving position (FIG. 23A) and when the blades reach the cleaning position (FIG. 23B).

The compression spring 434 is configured to be disposed in a compression spring recess 468 of the razor cartridge 400. The supporting rim 466 of the razor cartridge 400 may be an upper rim of the compression spring recess 468. The spring guidepost 458 of the actuator 412 is configured to fit into the compression spring 434 when the compression spring 434 is disposed in the compression spring recess 468. The compression spring 434 functions to continuously urge the actuator 412 toward its latched position (FIG. 23A) and to urge the blades 404 toward their shaving position (FIG. 23A). The compression spring recess 468 is illustrated herein as being positioned in the handle 402 that is removably attached to the razor cartridge 400. However, the compression spring recess 468 may alternatively be positioned in the blade housing 410 of the razor cartridge 400.

Referring more specifically to FIG. 23A, when the actuator 412 is in its latched position, the compression spring 434 has urged the actuator 412 laterally upward relative to the housing 410 until the arm end 464 of the actuator arm 456 clears the supporting rim 466 of the compression spring recess 468. The resilient actuator arm 456 then moves outward and over the supporting rim 466 to prevent the actuator from moving downward.

As the actuator 412 moves upward toward its latched position (FIG. 23A), the retention tabs 450 urge the non-cutting edges 408 of the blades 404 upward as each blade 404 is made to pivot around a respective pivot post 430. More specifically, blades 404A, 404B and 404° C. pivot around pivot posts 430A, 430B and 430C respectively.

Additionally, the pivot posts 430 are spaced apart by a distance that is substantially equal to the width of the blades 404 to pivotally affix the blades 404 therebetween. More specifically, pivot posts 430A and 430B pivotally affix blade 404A therebetween, pivot posts 430B and 430C pivotally affix blade 404B therebetween, and pivot posts 430C and 430D pivotally affix blade 404C therebetween.

When the actuator 412 reaches its latched position (FIG. 23A), the distal ends of each blade 404 abuts against a respective stop post 432 to prevent any further upward movement of the blades 404 or actuator 412. More specifically, stop posts 432B, 432C and 432D provide a positive upward stop for blades 404A, 404B and 404C respectively.

Referring more specifically to FIG. 23B, to move the actuator 412 into its unlatched position, a user must depress the resilient actuator arm 456 inwardly toward the blade housing 410 until the arm end 464 is moved off of the supporting rim 466. The arm end 464 may then be slid by the user downward into the compression spring recess 468 as the actuator 412 is moved downward toward its unlatched position (FIG. 23B).

As the actuator 412 moves downward toward its unlatched position (FIG. 23B), the retention tabs 450 urge the non-cutting edges 408 of the blades 404 downward as each blade 404 is made to pivot around a respective pivot post 430. More specifically, blades 404A, 404B and 404C pivot around pivot posts 430A, 430B and 430C respectively.

When the actuator 412 reaches its unlatched position (FIG. 23B), the distal ends of each blade 404 abuts against a respective stop post 432 to prevent any further downward movement of the blades 404 or actuator 412. More specifically, stop posts 432A, 432B and 432C provide a positive downward stop for blades 404A, 404B and 404C respectively.

The compression spring 434 is compressed when the actuator 412 is in its unlatched position, so the actuator 412 will only remain in it unlatched position if it is held there by a user. If the user releases the actuator 412, the compression spring 434 will urge the actuator 412 back to its latched position (FIG. 23B).

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

As may be recognized by those of ordinary skill in the art based on the teachings herein, numerous changes and modifications may be made to the above-described and other embodiments of the present disclosure without departing from the scope of the disclosure. The components of the razor cartridge as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. Accordingly, this detailed description of the currently-preferred embodiments is to be taken in an illustrative, as opposed to limiting of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a razor cartridge that “comprises,” “has,” “includes,” or “contains” one or more features possesses those one or more features, but is not limited to possessing only those one or more features. Furthermore, a razor cartridge that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations. Accordingly, it is intended that the disclosure not be limited to the described examples, but that it have the full scope defined by the language of the following claims.

What is claimed is:

1. A razor cartridge comprising:
a plurality of parallel blades, each blade including a longitudinal cutting edge and an opposing longitudinal non-cutting edge;
a blade housing configured to accommodate the plurality of blades therein, the blades positioned longitudinally across the blade housing, wherein the cutting edges of the blades form a shaving plane; and
a shifting mechanism configured to rotate the plurality of blades between a first shaving position and a cleaning position;
wherein in the first shaving position the blades are each oriented at an acute first shaving angle relative to the shaving plane and the blades are each spaced apart a first shaving distance measured perpendicularly between longitudinal side surfaces of two adjacent blades;
wherein in the cleaning position the blades are each oriented at a cleaning angle relative to the shaving plane and the blades are each spaced apart a cleaning distance measured perpendicularly between longitudinal side surfaces of two adjacent blades; and
wherein the cleaning angle is larger than the first shaving angle and the cleaning distance is larger than the first shaving distance.

2. The razor cartridge of claim 1, wherein the shifting mechanism is configured to rotate the blades between a plurality of shaving positions.

3. The razor cartridge of claim 1, wherein the razor cartridge is removably attached to a handle and a portion the shifting mechanism is positioned in the handle.

4. The razor cartridge of claim 1, comprising:
each blade of the plurality of blades having a control tooth disposed on a first end portion of a first distal end of the blade, the control tooth configured to engage with the shifting mechanism; and
each blade of the plurality of blades having an axle tooth disposed on a second end portion of the first distal end of the blade, the axle tooth configured to pivotally engage with the blade housing;
wherein, when the shifting mechanism rotates the plurality of blades between the first shaving position and the cleaning position, the shifting mechanism moves the control tooth of each blade arcuately between the first shaving position and the cleaning position while the axle tooth of each blade pivots on an axis of rotation of each blade.

5. The razor cartridge of claim 1, comprising:
the shifting mechanism being configured to rotate the plurality of blades between the first shaving position, a second shaving position and the cleaning position;
wherein in the second shaving position the blades are each oriented at an acute second shaving angle relative to the shaving plane and the blades are each spaced apart a second shaving distance;
wherein the second shaving angle is larger than the first shaving angle and smaller than the cleaning angle; and
wherein the second shaving distance is larger than the first shaving distance and smaller than the cleaning distance.

6. The razor cartridge of claim 1, wherein:
the cleaning angle is substantially between 80 and 110 degrees and the first shaving angle is substantially between 30 and 60 degrees.

7. The razor cartridge of claim 4, wherein the shifting mechanism comprises:
a rotation handle pivotally mounted on an outer surface of a sidewall of the blade housing, the rotation handle including a connecting pin guide slot extending along a length of the handle;
a blade rotating bar disposed within the blade housing and configured to be moved laterally along the blade housing, the blade rotating bar including a plurality of control tooth thru-holes, each control tooth thru-hole configured to receive a control tooth of each blade therethrough, the blade rotating bar including a connecting pin extending outwardly from the blade rotating bar, the connecting pin extending through a pin guide channel disposed in the sidewall of the blade housing and into the pin guide slot of the handle;
a plurality of control tooth channels disposed in an inner surface of the sidewall, each control tooth channels configured to receive a control tooth of each blade therein;
a plurality of axis of rotation holes disposed in the inner surface of the sidewall, each axis of rotation hole configured to receive an axle tooth of each blade therein;
a first shaving handle seat disposed in the outer surface of the sidewall of the blade housing, the first shaving handle seat configured to receive the handle therein, when the plurality of blades are in the first shaving position; and
a cleaning handle seat disposed in the outer surface of the sidewall of the blade housing, the cleaning handle seat configured to receive the handle therein, when the plurality of blades are in the cleaning position.

8. The razor cartridge of claim 7, wherein the shifting mechanism comprises:
a second handle seat disposed in the outer surface of the sidewall of the blade housing between the first handle seat and the cleaning handle seat, the second handle seat configured to receive the handle therein;
wherein when the handle is in the second handle seat, the plurality of blades are in a second shaving position.

9. The razor cartridge of claim 7, wherein when the handle is pivoted from the first shaving handle seat to the cleaning handle seat:
the connecting pin guide slot of the handle urges the connecting pin to move arcuately along the pin guide channel in the sidewall of the blade housing;
the connecting pin urges the blade rotating bar to move laterally within the blade housing; and
the plurality of control tooth thru-holes of the blade rotating bar urge each control tooth of each blade to move along an associated control tooth channel to pivot the plurality of blades from the shaving position to the cleaning position.

10. The razor cartridge of claim 4, wherein the shifting mechanism comprises:
a lock base disposed on a peripheral portion of an open bottom of the blade housing, the lock base having a cleaning lock seat and a first shaving lock seat disposed thereon;
a face frame, pivotally connected to the open bottom of the blade housing by a first and a second spring loaded hinge, the face frame configured to be pivoted on the first and second hinges from a first lock position to a down position, the face frame comprising:
a plurality of control tooth holes configured to receive each control tooth of each blade therein; and
a lock pin configured to engage with the cleaning lock seat and the first shaving lock seat;
wherein when the face frame is in the first lock position, the lock pin is engaged with the first shaving lock seat and the plurality of blades are in the first shaving position, and
wherein when the face frame is in the down position, the lock pin is engaged with the cleaning lock seat and the plurality of blades are in the cleaning position.

11. The razor cartridge of claim 10, wherein the shifting mechanism comprises:
a second lock seat disposed in the lock base between the cleaning lock seat and the first lock seat, the second lock seat is configured to receive the lock pin therein;
wherein when the lock pin is in the second lock seat, the plurality of blades are in a second shaving position.

12. The razor cartridge of claim 4, wherein the shift mechanism comprises:
a wheel rotationally mounted on an outer surface of a first sidewall of the blade housing;
a shaft connected centrally to the wheel and rotatable by the wheel, the shaft extending longitudinally through the blade housing;
a first gear tooth and an opposing second gear tooth extending radially outward from the shaft at substantially 180 degrees from each other, the first gear tooth and the second gear tooth are positioned proximate an inner surface of the first sidewall of the blade housing;
a first slide bar positioned below the shaft, the first slide bar comprising:
a slide bar body configured to slide laterally along a slide track that is attached to the blade housing;
a plurality of control tooth tracks extending downward from a side of the slide bar body, each control tooth track configured to receive a control tooth of each blade therethrough; and
a slide tooth extending upward from an opposing side of the slide bar body, the slide tooth configured to engage with the first and second gear teeth;
a locking pin positioned above the shaft, the locking pin configured to engage with the first and second gear teeth;
a plurality of control tooth channels disposed in the inner surface of the first sidewall, each control tooth channel configured to receive a control tooth of each blade therein;
a plurality of axis of rotation holes disposed in the inner surface of the sidewall, each axis of rotation hole configured to receive an axle tooth of each blade therein; and
a spring configured to engage with a distal end of the first slide bar.

13. The razor cartridge of claim 12, wherein the shifting mechanism comprises a locked position and an unlocked position, wherein:
when the shifting mechanism is in the locked position:
one of the first or second gear teeth is engaged against the slide tooth to urge the first slide bar against the spring and compress the spring into a compressed position;
another of the first and second gear teeth is engaged against the locking pin to prevent the compressed spring from moving the first slide bar laterally along the slide track;
the control teeth of each of the blades are positioned by the plurality of control tooth tracks and control tooth channels such that the blades are pivoted into the first shaving position; and
when the shifting mechanism is in the unlocked position:
the first and second gear teeth are disengaged from the slide tooth and the locking pin,
the spring is extended into an extended position to move the first slide bar laterally along the slide track; and
the control teeth of each of the blades are positioned by the plurality of control tooth tracks and control tooth channels such that the blades are pivoted into the cleaning position.

14. The razor cartridge of claim 1, comprising:
the shifting mechanism comprising an actuator, the actuator movable from a latched position to an unlatched position, the actuator comprising:
a base plate having a first surface and an opposing second surface, the first surface of the base plate being configured to abut against an outer surface of a rear wall of the housing, the base plate configured to move laterally up and down the rear wall of the housing between the latched position and the unlatched position of the actuator;
a first set of retention tabs positioned within the blade housing and connected to the base plate, the first set of retention tabs configured to engage with the non-cutting edges of the blades; and
a locking arm connected to the second surface of the base plate, the locking arm extending laterally downward from the base plate to an unattached arm end, the arm end configured to be resiliently movable from a first arm position to a second arm position;
wherein when the arm end is in the first arm position, the arm end is configured to engage against a supporting rim of the razor cartridge to lock the actuator in the latched position and to enable the retention tabs to hold the blades in the first shaving position; and
wherein when the arm end is in the second arm position, the arm end is configured to disengage from the supporting rim to enable the actuator to be moved to the unlatched position and to enable the retention tabs to move the blades to the cleaning position.

15. The razor cartridge of claim 14, comprising:
a first and a second end cap disposed on opposing longitudinal sides of the blade housing, each end cap comprising:
a set of pivot posts configured to engage with the blades such that each blade pivots around a respective pivot post as the actuator moves from the latched position to the unlatched position; and
a set of stop posts configured to engage with the blades such that the stop posts provide a positive stop for each blade when the blades reach the first shaving position and when the blades reach the cleaning position.

16. The razor cartridge of claim 15, comprising:
the rear wall of the blade housing including a laterally extending first guide slot; and
the actuator comprising:
a first tab plate upon which the first set of retention tabs are disposed; and
a first plate stem connecting the first tab plate to the base plate through the first guide slot, wherein the first guide slot guides the actuator base plate laterally up and down as the actuator moves from the latched position to the unlatched position.

17. The razor cartridge of claim 16, wherein:
the blade housing comprises the first, a second and a third guide slot;
the actuator comprises the first, a second and a third set of retention tabs respectively disposed on the first, a second and a third tab plate; and
the actuator also comprises the first, a second and a third plate stem respectively connecting the first, second and third tab plates to the base plate through the first, second and third guide slots.

18. A razor cartridge comprising:
a plurality of parallel blades, each blade including a longitudinal cutting edge and an opposing longitudinal non-cutting edge;
a blade housing configured to accommodate the plurality of blades therein, the blades positioned longitudinally across the blade housing; and
an actuator configured to rotate the plurality of blades between a shaving position and a cleaning position, the actuator being movable from a latched position to an unlatched position,
the actuator comprising:
a base plate having a first surface configured to abut against an outer surface of a rear wall of the housing and an opposing second surface, the base plate configured to move laterally up and down the rear wall between the latched position and the unlatched position of the actuator;
a first set of retention tabs positioned within the blade housing and connected to the base plate, the retention tabs configured to engage with the non-cutting edges of the blades; and
a locking arm connected to the second surface of the base plate, the locking arm extending laterally downward from the base plate to an unattached arm end, the arm end configured to be resiliently movable from a first arm position to a second arm position;
wherein when the arm end is in the first arm position, the arm end is configured to engage against a supporting rim of the razor cartridge to lock the actuator in the latched position and to enable the retention tabs to hold the blades in the shaving position; and
wherein when the arm end is in the second arm position, the arm end is configured to disengage from the supporting rim to enable the actuator to be moved to the unlatched position and to enable the retention tabs to move the blades to the cleaning position.

19. The razor cartridge of claim 18, comprising:
a first and a second end cap disposed on opposing longitudinal sides of the blade housing, each end cap comprising:
a set of pivot posts configured to engage with the blades such that each blade pivots around a respective pivot post as the actuator moves from the latched position to the unlatched position; and
a set of stop posts configured to engage with the blades such that the stop posts provide a positive stop for each blade when the blades reach the shaving position and when the blades reach the cleaning position.

20. The razor cartridge of claim 19, comprising:
the rear wall of the blade housing including a laterally extending first guide slot; and
the actuator comprising:
a first tab plate upon which the first set of retention tabs are disposed, and
a first plate stem connecting the first tab plate to the base plate through the first guide slot;
wherein the first guide slot guides the actuator base plate laterally up and down as the actuator moves from the latched position to the unlatched position.

21. The razor cartridge of claim 20, wherein:
the blade housing comprises the first, a second and a third guide slot;
the actuator comprises the first, a second and a third set of retention tabs respectively disposed on the first, a second and a third tab plate; and
the actuator also comprises the first, a second and a third plate stem respectively connecting the first, second and third tab plates to the base plate through the first, second and third guide slots.

22. The razor cartridge of claim 18, comprising:
a compression spring, configured to be disposed in a compression spring recess of the razor cartridge, wherein the supporting rim of the razor cartridge comprises an upper rim of the compression spring recess; and
the actuator comprising a spring guidepost configured to fit into the compression spring when the compression spring is disposed in the compression spring recess;
wherein, the compression spring continuously urges the actuator toward its latched position and the blades toward the shaving position.

23. The razor cartridge of claim 22, wherein the razor cartridge is removably attached to a handle and the compression spring recess is positioned in the handle.

24. The razor cartridge of claim 22, wherein the compression spring recess is positioned in the blade housing.
